(19) United States
(12) Patent Application Publication
(10) Pub. No.: US 2008/0287579 A1
(43) Pub. Date: Nov. 20, 2008

(54) Resin composition and resin mold

(75) Inventors: Masayuki Okoshi, Kanagawa (JP); Masato Mikami, Kanagawa (JP); Kazuya Yamanoi, Kanagawa (JP); Kenji Yao, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 12/076,186

(22) Filed: Mar. 14, 2008

(30) Foreign Application Priority Data
May 17, 2007 (JP) 2007-132026
Aug. 31, 2007 (JP) 2007-226570

(51) Int. Cl. C08K 5/3492; C08K 5/41; C08K 5/13

(52) U.S. Cl. 524/100; 524/156; 524/323

(57) ABSTRACT

A resin composition includes a resin; a radical trapping agent that has at least one of a phenol group, a nitrogen atom and a sulfuric acid group; and a char-forming agent that has a carbonate group.

### CROSS-REFERENCE TO RELATED APPLICATIONS

This application is based on and claims priority under 35 USC 119 from Japanese Patent Application Nos. 2007-132026 and 2007-226570 filed on May 17, 2007 and Aug. 31, 2007, respectively.

### BACKGROUND

1. Technical Field

The present invention relates to a resin composition and a resin mold.

2. Related Art

In resin materials that are required to be flame resistant, a flame retardant is conventionally blended for the purpose of flameproofing. As the flame retardant mixed with resin materials, for example, halogen compounds and phosphorus compounds are widely known. However, in the case of petroleum resin materials, there are tendencies to avoid blending of halogen compounds having the possibility of generation of dioxine in incineration. Accordingly, in recent years, as the flame retardant, phosphorus compounds are used in many cases as the substitute of halogen compounds.

However, of phosphorus compounds, the most widely used ester bond-containing materials such as phosphoric acid esters bring about hydrolysis of the esters by the phosphoric acids of the compounds themselves, which causes degradation, and generates deteriorations of mechanical characteristics, recycling properties and processability. Therefore, it has been difficult to use phosphorus compounds as the materials of bodies of equipments such as copiers and printers having hot sections inside.

Accordingly, resin materials containing a flame retardant other than halogen compounds and phosphorus compounds are required.

### SUMMARY

According to an aspect of the invention, there is provided a resin composition including a resin; a radical trapping agent that has at least one of a phenol group, a nitrogen atom and a sulfuric acid group; and a char-forming agent that has a carbonate group.

### BRIEF DESCRIPTION OF THE DRAWINGS

Exemplary embodiment(s) of the present invention will be described in detail based on the following figures, wherein:

FIG. 1 is a diagonal view of external appearance of the body and the image-forming apparatus equipped with business equipments according to an exemplary embodiment of the invention; and

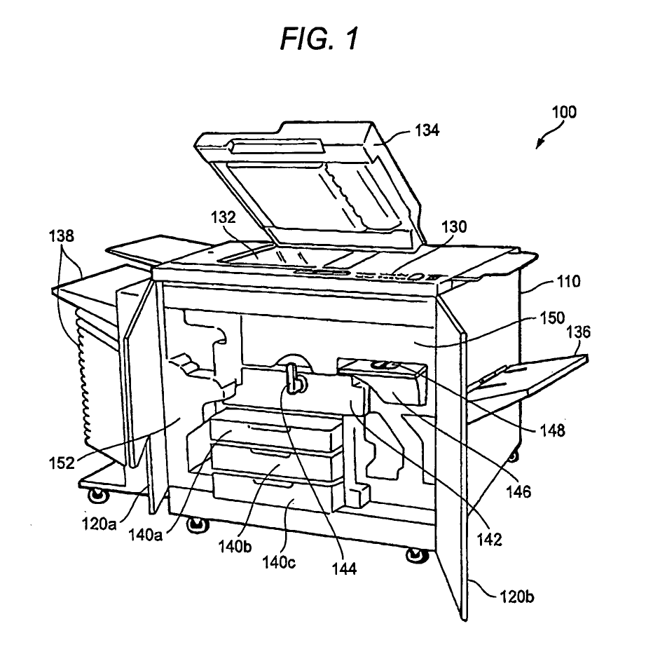

FIG. 2 is a view illustrating TG curve of one-step mass reduction in thermogravimetry in conformity with JIS K7120.

### DETAILED DESCRIPTION

Exemplary embodiments of the invention will be described in detail below with reference to the Figure, if necessary. In the Figure, the same signs are attached to the same or corresponding parts and duplicating description is omitted.

The resin composition according to an aspect of the invention contains a resin, a radical trapping agent having one or more of a phenol group, a nitrogen atom and a sulfuric acid group, and a char-forming agent having a carbonate group.

The resins are not especially restricted, and, for example, acrylonitrile-butadiene-styrene copolymer (ABS), methylpentene, thermoplastic vulcanized elastomer, thermoplastic polyurethane, styrene-isoprene-styrene block copolymer, silicone, styrene-ethylene-propylene-styrene block copolymer, styrene-ethylene-butylene-styrene block copolymer, styrene-butadiene-styrene block copolymer, styrene-butadiene rubber, styrene-butadiene copolymer, acrylonitrile-styrene copolymer, polyvinyl pyrrolidone, polyvinyl alcohol, polyvinyl methyl ether, polyvinyl isobutyl ether, polyvinyl formal, polyvinyl butyral, polyvinyl acetate, polytrimethylene terephthalate, polysulfone, polystyrene, polyphenylene sulfide, polyphenylene ether, polypropylene, polyphthalamide, polyoxymethylene, polymethylpentene, methyl polymethacrylate, polymethacrylonitrile, polymethoxy acetal, polyisobutylene, thermoplastic polyimide, polyethylene terephthalate, polyether sulfone, polyethylene naphthalate, polyether nitrile, polyether imide, polyether ether ketone, polyethylene, polycarbonate, polybutylene terephthalate, polybutadienestyrene, polyparaphenylenebenzobisoxazole, poly-n-butyl methacrylate, polybenzimidazole, polybutadiene acrylonitrile, polybutene-1, polyallylsulfone, polyallylate, polyacrylonitrile, thermoplastic polyester alkyd resin, thermoplastic polyamideimide, polyacrylic acid, polyamide, natural rubber, nitrile rubber, methyl methacrylate butadiene styrene copolymer, polyethylene, isoprene rubber, ionomer, butyl rubber, furan resin, ethylene-vinyl alcohol copolymer, ethylene-vinyl acetate copolymer, ethylene-propylene-diene terpolymer, cellulose propionate, hydrin rubber, carboxymethyl cellulose, cresol resin, cellulose acetate propionate, cellulose acetate butyrate, cellulose acetate, bismaleimidetriazine, cis1·4-polybutadiene synthetic rubber, acrylonitrilestyrene acrylate, acrylonitrile-styrene copolymer, acrylonitrile-ethylene-propylene-styrene copolymer, acrylate rubber, polylactic acid, etc., are exemplified. These resins may be used by one kind alone, or two or more kinds may be used in combination.

The resin is preferably a compound having at least one of a styrene group and a phenylcarbonate group for being excellent in compatibility with the char-forming agent and capable of obtaining more excellent flame resistance. When the char-forming agent is a compound having a phenylcarbonate group, the compatibility with the resin having at least one of a styrene group and a phenylcarbonate group becomes very good. As the resin having at least one of a styrene group and a phenylcarbonate group, the ones containing one or more of acrylonitrile-butadiene-styrene copolymer (ABS), polycarbonate (PC), polystyrene (PS), acrylonitrile-styrene copolymer (AS), styrenephosphonic acid resin, styreneformalin resin, or styrol are preferably used. When the resin mold is used as the bodies of equipments such as copiers and printers, acrylonitrile-butadiene-styrene copolymer (ABS) is especially preferred.

The radical trapping agent is not especially restricted so long as the agent has one or more of a phenol group, a nitrogen atom and a sulfuric acid group, and capable of trapping active radicals occurring at the time of combustion of the rubber. As such radical trapping agents, compounds having an electron attracting property are exemplified and, for example, sulfuric acid salts, and of the sulfuric acid salts, molecules having counter ions constituted of the groups other than Ia groups in the Periodic Table are preferred, because it is possible that Ia groups are dissolved in water and easily deteriorates resin characteristics. Radical trapping agents having organic counter ions are preferred, for example, the salts of the compounds containing melamine sulfate, guanidine sulfate or benzene and sulfonic acid, e.g., barium aminobenzene-sulfonate, aluminum benzimidazolesulfonate, etc., are exemplified. These can be used by one kind alone, or two or more kinds may be used in combination.

As the radical trapping agent, it is also preferred to use in combination of compound A comprising N, C, H and O and having the combustion residue of 0% at 500° C. with compound B having a sulfuric acid group and having the combustion residue of 0% at 500° C. By using in combination of compounds A and B having no residue alone, excellent flame resistance can be obtained like this. As compound A, e.g., melamine cyanurate is exemplified, and as compound B, e.g., melamine sulfate is exemplified.

As the radical trapping agent, it is also preferred to use a compound having a decomposition point of 400° C. or less, or a compound having two or more sulfuric acid groups per one molecule, and it is more preferred to use a compound having a decomposition point of 400° C. or less and having two or more sulfuric acid groups per one molecule.

Further, from the viewpoint of attracting free radicals, the radical trapping agent is preferably a compound having one or more of a phenol group, a nitrogen atom and a sulfuric acid group, and is more preferably a compound having a sulfuric acid group.

Further, from the viewpoint that the radical trapping material is decomposed before the resin and waiting for the decomposed product of the resin decomposing afterward, the radical trapping agent is preferably a compound having a decomposition temperature lower than that of the resin in thermogravimetry in conformity with JIS K7120. As the specific decomposition temperature of the radical trapping agent is preferably from 200 to 500° C., and more preferably from 250 to 450° C.

### Thermogravimetric Measurement:

This is performed by the method of measuring the mass of a substance as a function of temperature or time while varying the temperature of the substance according to a controlled program. Usually, the change in mass of a specimen is measured as a function of temperature.

### <Measurement Conditions>

### Specimen:

A specimen in a powder form or in a finely cut state is used in an amount of 10 mg or less.
Gas Flow Rate: from 50 to 100 (ml/min)

### Analysis Method:

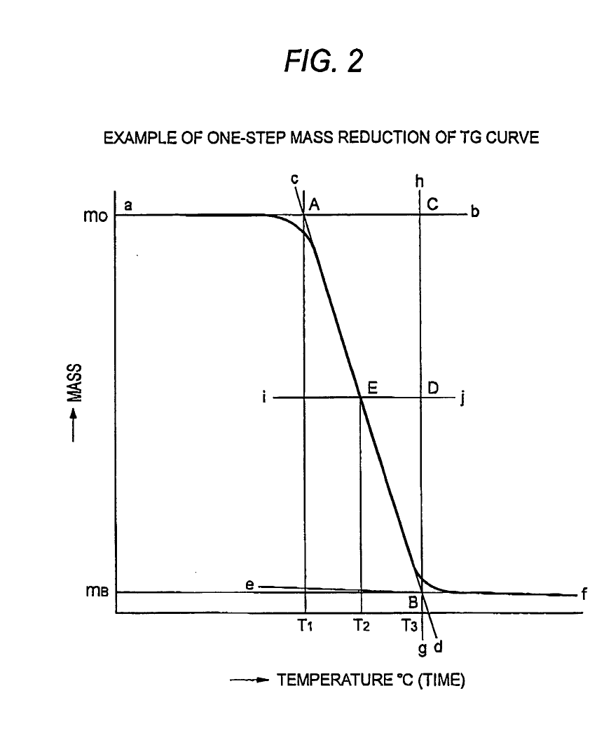

The method of (2) below comprising, as shown in FIG. 2, steps (a) to (j) is employed.

### (2) One-Step Mass Reduction

(a) In FIG. 3, a line (a-b) passing through the mass m₀ before the initiation of a test by heating and being parallel to the abscissa is drawn.

(b) A tangent line (c-d) is drawn to give a maximum gradient between the folding points in the TG curve.

(c) A tangent line (e-f) is drawn on the curve where the change in mass is almost not observed.

(d) The temperature at the point A of the line (a-b) intersecting with the tangent line (c-d) is designated as the initiation temperature T₁.

(e) The temperature at the point B of the tangent line (c-d) intersecting with the tangent line (e-f) is designated as the finish temperature T₃.

(f) The mass corresponding to the intersection B is designated as m_{B}.

(g) A line (g-h) passing through the point B and being parallel to the ordinate is drawn.

(h) The midpoint of a straight line connecting he point C of the line (a-b) intersecting with the line (g-h) and the point B is designated as the point D.

(i) A straight line (i-j) passing through the point D and being parallel to the abscissa is drawn.

(j) The temperature at the point E of the line (i-j) intersecting with the TG curve is designated as the midpoint temperature T₂.

The content of the radical trapping agent in the resin composition according to an aspect of the invention is preferably from 0.1 to 50 mass parts per 100 mass parts of the resin, and more preferably from 5 to 30 mass parts. When the content is less than 0.1 mass parts, the flame resistance of the resin mold to be obtained is liable to be insufficient, while when the content exceeds 50 mass parts, the mechanical characteristics of the resin mold to be obtained is liable to lower.

The char-forming agent is not especially restricted so long as it has a carbonate group and is capable of forming a carbonized layer by combustion, and, resins, e.g., phenyl-polystyrene carbonate, and polycarbonate, and compounds, e.g., polyphenylene ether, diphenyl carbonate, triphenyl dicarbonate are exemplified. They can be used by one kind alone, or two or more kinds can be used in combination.

Further, from the viewpoint of the increase in the residual amount after heat decomposition, the char-forming agent is preferably a compound having a phenylcarbonate group. When the char-forming agent has a phenylcarbonate group, the content of the phenylcarbonate group is preferably about 35 mass % or more based on all the content of the char-forming agent, and more preferably from about 35 to about 50 mass %. When the content of the phenylcarbonate group is less than 35 mass %, formation of a carbonized layer at the time of combustion is insufficient and flame resistance of the resin mold is liable to lower.

Further, from the viewpoints of formation of char in the early stage of combustion, insulation of radiant heat from the combusting area, and restraint of diffusion of the decomposed product, the char-forming agent is preferably a compound having a decomposition temperature lower than that of the resin in thermogravimetry in conformity with JIS K7120. The specific decomposition temperature of the char-forming agent is preferably from 200 to 500° C., and more preferably from 250 to 450° C.

Further, from the viewpoint of the increase in the residual amount after heat decomposition, the residual rate at 600° C. of the char-forming agent is preferably equal to or higher than that of the resin. The specific residual rate of the char-forming agent at 600° C. is preferably from 0.1 to 99.9%, and more preferably from 1 to 50%.

The content of the char-forming agent in the resin composition according to an aspect of the invention is preferably from 0.1 to 100 mass parts per 100 mass parts of the resin, more preferably from 5 to 50 mass parts, and still more preferably from 5 to 20 mass parts. When the content is less than 0.1 mass parts, the flame resistance of the resin mold to be obtained is liable to be insufficient, while when it exceeds 100 mass parts, the mechanical characteristics and processability is liable to lower.

The resin composition according to an aspect of the invention may contain a drip preventive. The drip preventive is to raise the melting viscosity of the resin (dripped product) melting by the radiant heat from the combusting area, and fine particles, e.g., silica and carbon black, and acicular fillers, e.g., acicular boehmite, are exemplified. The drip preventive may be used by one kind alone, or two or more kinds may be used in combination. When the resin composition contains the drip preventive, drip of the resin mold obtained can be prevented.

When the resin composition according to an aspect of the invention contains a drip preventive, the content is preferably from 0.1 to 10 mass parts per 100 mass parts of the resin composition, and more preferably from 0.1 to 5 mass parts. When the content is less than 0.1 mass parts, drip-preventing effect of the resin mold is liable to be insufficient, while when the content exceeds 10 mass parts, the mechanical characteristics and processability is liable to lower.

It is preferred for the resin composition according to an aspect of the invention to contain an impact resistance improver. The impact resistance improver is to relax the impact given to the resin, and those dispersed spherically in the resin are preferred. Polybutadiene of terminal modification with vinyl acryl styrene to ABS, butadiene of terminal modification with styrene to PS, a rubber-like compound of terminal modification with carbonate to PC are exemplified, although not limitative. The impact resistance improvers can be used by one kind alone, or two or more kinds can be used in combination. When the resin composition contains the impact resistance improver, as to the mechanical characteristics (in particular, impact resisting strength) of the resin mold to be obtained, equal or higher characteristics can be revealed as compared with the time when the flame retardant is added.

When the resin composition according to an aspect of the invention contains the impact resistance improver, the content is preferably from 0.1 to 20 mass parts, and more preferably from 0.1 to 10 mass parts based on 100 mass parts of the resin. When the content is less than 0.1 mass parts, the effect to improve mechanical characteristics of the resin mold is liable to be insufficient, while when the content exceeds 20 mass parts, the resin itself softens and the modulus of elasticity is liable to lower, since the impact resistance improver is originally a flexible material with a view to relaxing impact.

Further, the resin composition according to an aspect of the invention may contain additives other than the components described above. As such additives, for example, a compatibility improving agent, a reinforcing agent, an antioxidant, a weather proofing agent, a plasticizer, a lubricant, a colorant, a crystalline nucleus agent, a foaming agent, an antistatic agent, and an antiseptic are exemplified. The contents of these additives are not especially restricted so long as the advantage of the invention is not impaired, but the content is preferably 50 mass parts or less per 100 weight parts of the resin.

When polycarbonate (PC) and polylactic acid (PLA) are used in combination as the resins constituting the resin composition according to an aspect of the invention, they are inferior in compatibility, and the mechanical characteristics of the resin mold to be obtained is deteriorated. However, the compatibility of both resins can be bettered by further using bismaleimidetriazine (BT), and the mechanical characteristics of the resin mold to be obtained can be improved. Further, when the resin composition contains a phosphorus series flame retardant, bleeding of the phosphorus flame retardant can be prevented by the use of bismaleimidetriazine.

Further, it is preferred for the resin composition according to an aspect of the invention not to substantially contain a halogen compound from an environmental point of view, and it is preferred not to substantially contain a phosphorus compound from a standpoint of recycling properties. In the resin composition in the invention, the specific contents of a halogen compound and a phosphorus compound are respectively preferably 0.5 mass % or less based on all the amount of the resin composition.

When the compound having a decomposition point of 400° C. or less described above is used as the radical trapping agent, it is preferred for the resin composition in the invention to further contain an additive showing endothermic reaction with the compound having a decomposition point of 400° C. or less, by which flame resistance of the resin mold to be obtained can further be improved. As the above additives, e.g., salts or hydroxides of Li, Be, B, Na, Mg, Al, K, Ca, Sc, Ti, V, Cr, Mn, Fe, Co, Ni, Cu, Zn, Ga, Rb, Sr, Cs and Ba are exemplified. As the additive, calcium hydroxide is preferred of these additives. Further, when these additives are used, the compound having a decomposition point of 400° C. or less is preferably a compound having one or more sulfuric acid groups or nitric acid groups per one molecule.

As the additive showing endothermic reaction with the compound having a decomposition point of 400° C. or less, for the purpose of preventing foaming from occurring due to dehydration reaction between the additive and the resin in the resin composition, it is preferred to use surface-covered particles having covering layers containing an organic compound on the surface thereof with the particles comprising the additive as the nucleus particles.

The organic compounds for forming covering layers are not especially restricted, but compounds having an organic group capable of bonding to the nucleus particles may be used. By bonding such an organic group to the nucleus particles, a thin organic layer can be homogeneously formed on the surfaces of the particles. It is preferred that the organic group in the organic compound has a bonding group on the terminal to form a bond with the nucleus particle. As the bonding group, an ionic group (an anionic group or a cationic group) and a hydrolyzable group are exemplified, and the bonding formed between the nucleus particle and the organic group may be an ionic bond or a covalent bond.

As the organic groups of the organic compound, groups capable of functioning as a hydrophobic group of surfactant (e.g., a higher fatty acid residue, a higher alcohol residue, an alkylaryl group, etc.), and a polyamino acid residue are exemplified.

As the organic compound for forming a covering layer, polysilicone is also preferably used.

The manufacturing method of the surface-covered particles is not restricted and any known method can be used. As the specific examples of the manufacturing method of the surface-covered particles, for example, the following methods are exemplified: that is, (i) a method of dispersing nucleus particles in an aqueous solution having dissolved therein a metal salt of an organic compound and a dispersant, dropping an acidic aqueous solution to the dispersion and precipitating the organic compound on the surfaces of the nucleus particles to form covering layers, (ii) a method of dispersing nucleus particles in a solution obtained by dissolving an organic compound and a dispersant in an organic solvent miscible with water, dropping water to the dispersion and precipitating the organic compound on the surfaces of the nucleus particles to form covering layers (iii) a method of dispersing nucleus particles in an aqueous solution having dissolved therein a dispersant, dropping a polyamino acid salt aqueous solution to the dispersion and precipitating the polyamino acid on the surfaces of the nucleus particles to form covering layers, (iv) a method of dissolving metal salts containing one or more kinds of metals selected from Mg, Ca, Al, Fe, Zn, Ba, Cu and Ni, and a surfactant in water to prepare metal soap particles having a micelle structure or a bicycle structure, developing the metal soap particles in an organic solvent and phase inverting to invert micelle particles, and making a base act on the metal ions contained in the invert micelle particles to prepare metal hydroxide, (v) a method of preparing a developing solution by developing organic compound metal salts containing one or more kinds of metals selected from Mg, Ca, Al, Fe, Zn, Ba, Cu and Ni in an organic solvent, and making a base act on the metal ions contained in the organic compound metal salts to make metal hydroxide, (vi) a method of preparing an aqueous solution having dissolved therein organic compound metal salts containing one or more kinds of metals selected from Mg, Ca, Al, Fe, Zn, Ba, Cu and Ni, and a dispersant or a chelating compound, dropping a metal ion aqueous solution to the above aqueous solution, and making a base act on the aqueous solution containing the metal ions to make the metal ions contained in the organic compound metal salts to metal hydroxide, and (vii) a method of making the vaporized product of a cyclic organosiloxane compound act on nucleus particles, and forming covering layers by ring opening polymerization of the cyclic organosiloxane compound on the surfaces of the nucleus particles.

Since the resin composition in the invention has a constitution containing a resin, a radical trapping agent having one or more of a phenol group, a nitrogen atom and a sulfuric acid group, and a char-forming agent having a carbonate group, the resin composition is excellent in processability and capable of molding a resin mold having sufficient flame resistance, excellent in mechanical characteristics and recycling properties.

In the next place, the resin mold according to an aspect of the invention is described. The resin mold in the invention is formed with the resin composition of the invention. That is, the resin mold according to an aspect of the invention contains the resin, the radical trapping agent having one or more of a phenol group, a nitrogen atom and a sulfuric acid group, and the char-forming agent having a carbonate group. Further, the resin mold in the invention may contain, similarly to the resin composition, a drip preventive, an impact resistance improver, and other additives, if necessary.

The resin mold according to an aspect of the invention can be obtained by molding the resin composition in the invention by known methods, e.g., injection molding, injection compression molding, press molding, extrusion molding, blow molding, calender molding, coating molding, cast molding, or dip molding.

The use of the resin mold in the invention is not especially restricted and, for example, bodies and various components of household electric appliances and business equipments, wrapping films, casings of CD-ROM and DVD, tableware, food trays, bottles of beverages, wrappings of medicines and the like are exemplified.

Since the resin mold in the invention has a constitution containing the resin, the radical trapping agent having one or more of a phenol group, a nitrogen atom and a sulfuric acid group, and the char-forming agent having a carbonate group, sufficient flame resistance, excellent in mechanical characteristics and recycling properties can be obtained. Further, the resin mold in the invention can obtain the flame resistance equivalent to V-2 or higher in UL-94 standard and, at the same time, can suppress combusting speed to half or less of the case of using a simple material of resin in Cone Calorimeter Test of ISO5660-1.

Further, since the resin mold in the invention can obtain sufficient flame resistance without using flame retardants such as halogen compounds that are of origin of generation of dioxine and highly hygroscopic phosphorus compounds, the resin mold is very useful from the viewpoints of environmental problems and recycling properties. Further, the resin mold in the invention can sufficiently restrain degradation by heat, so that very useful as the bodies of equipments such as copiers and printers having hot sections inside.

The Figure is a diagonal view of external appearance of the body and the image-forming apparatus equipped with business equipments according to an exemplary embodiment of the invention viewed from the front side. In the Figure, image-forming apparatus 100 is equipped with front covers 120a and 120b in front of body apparatus 110. These front covers 120a and 120b are capable of opening and closing so that the operator can operate the inside of the apparatus. By such a structure, the operator can replenish consumed toners, exchange a consumed process cartridge, and remove jammed paper when the apparatus is jammed up. The Figure is a view showing the apparatus of the state of front covers 120a and 120b being opened.

On body apparatus 110 are provided panel 130 to which various conditions concerning image formation such as paper size and the number of copies are input by the operation from the operator, and copy glass 132 to on which the original to be read is arranged. On the upper side of body apparatus 110, automatic original conveyor 134 capable of automatically conveying the original onto copy glass 132 is equipped. Further, body apparatus 110 is equipped with an image reading apparatus of scanning the original image arranged on copy glass 132 and obtaining the image data. The image data obtained by the image reading apparatus is sent to the image-forming unit via a control unit. The image reading apparatus and the control unit are encased in the inside of body 150 constituting a part of body apparatus 110. The image-forming unit is provided in body 150 as attachable and detachable process cartridge 142. Attachment and detachment of process cartridge 142 becomes capable by turning operation lever 144.

Body 150 of body apparatus 110 is equipped with toner holder 146, and toner can be replenished from supply port 148. The toner in toner holder 146 is to be supplied to a developing unit.

On the other hand, paper holding cassettes 140a, 140b and 140c are provided on the lower part of body apparatus 110. In body apparatus 110, by arranging several pairs of conveying rollers, a conveying route of paper in the paper holding cassette to be conveyed to the upper image-forming unit is formed. Paper in each paper holding cassette is taken out one by one with paper-taking unit arranged in the vicinity of the end of the conveying route and delivered to the conveying route. On the side of body apparatus 110 is provided manual paper feed tray 136, and paper can also be fed from here.

Paper on which an image is formed with the image-forming unit is conveyed between two fixing rollers attaching to each other and supporting by body 152 constituting a part of body apparatus 110, and discharged to the outside of body apparatus 110. Body apparatus 110 is equipped with a plurality of discharge trays 138 on the side opposite to the side on which manual paper feed tray 136 is provided, and paper after image formation is discharged to these trays.

In image-forming apparatus 100, a heavy load is applied to front covers 120a and 120b, such as stress and impact at the time of opening and shutting, vibration at the time of image formation, heat generated in the image-forming unit, and the like. A heavy load is also applied to process cartridge 142, such as impact by attachment and detachment, vibration at the time of image formation, heat generated in the image-forming unit, and the like. A heavy load is also applied to body 150 and body 152, such as vibration at the time of image formation, heat generated in the image-forming unit, and the like. Accordingly, it is preferred to use the resin mold in the invention as front covers 120a and 120b of image-forming apparatus 100, the outer package of process cartridge 142, and body 150 and body 152.

### EXAMPLE

The invention will be described more specifically with reference to examples and comparative examples, but the invention should not be construed as being restricted thereto.

### Examples 1 to 4 and Comparative Examples 1 to 7

A resin composition containing each component shown in Table 1 below in blending amount (unit: mass part) shown in the table is kneaded in a biaxial extruder (model 58SS, manufactured by Toshiba Machine Co., Ltd.), and injection molded with an injection molding press (model NEX360, manufactured by Nissei Plastic Industrial Co., Ltd.) on the condition of cylinder temperature of 220° C. and mold temperature of 40° C. to obtain ISO multipurpose dumbbell test piece (thickness; 40 mm, width: 10 mm) and UL test piece (thickness: 2.0 mm).

TABLE 1

| | | | Example | | | | Comparative Example | | | | | | |
|---|---|---|---|---|---|---|---|---|---|---|---|---|---|
| | | | 1 | 2 | 3 | 4 | 1 | 2 | 3 | 4 | 5 | 6 | 7 |
| Resin | ABS | AT-05 (block polymerized | 100 | 100 | 100 | 100 | 100 | 100 | 100 | — | — | 100 | 100 |
| | | product, manufactured by | | | | | | | | | | | |
| | | Nippon A & L Inc.) | | | | | | | | | | | |
| | PC | L1225Y (manufactured by | — | — | — | — | — | — | — | — | 100 | 20 | 20 |
| | | Teijin Chemicals Ltd.) | | | | | | | | | | | |

| | | | | | | | | | | | | |
|---|---|---|---|---|---|---|---|---|---|---|---|---|
| Char- | Phenylpolystyrene carbonate | 5 | 50 | 20 | 30 | — | 50 | — | 100 | — | — | — |
| forming | | | | | | | | | | | | |
| agent | | | | | | | | | | | | |
| Radical | Melamine sulfate | 20 | 5 | 20 | 20 | — | — | 50 | — | — | — | 20 |
| trapping | (manufactured by Kanto | | | | | | | | | | | |
| agent | Chemical Co., Inc.) | | | | | | | | | | | |
| Phosphoric | CR-741 | — | — | — | — | — | — | — | — | — | 20 | — |
| acid | (manufactured by Daihachi | | | | | | | | | | | |
| polyester | Chemical Industry Co., Ltd.) | | | | | | | | | | | |

| | | | | | | | | | | | |
|---|---|---|---|---|---|---|---|---|---|---|---|
| Total amount | 125 | 155 | 140 | 150 | 100 | 150 | 150 | 100 | 100 | 140 | 140 |

In Table 1, phenylpolystyrene carbonate as the char-forming agent is synthesized in the following procedure. A stirrer is put in a glass flask having a capacity of 200 ml equipped with a cooling pipe, and 0.2 g of poly(4-vinylphenol) (weight average molecular weight: about 8,000, manufactured by Sigma Aldrich Japan K.K.), 18 g of diphenyl carbonate, and 10 mg of 4-dimethyaminopyridine are introduced thereto. After substituting with nitrogen in the container, reaction is initiated by putting the container in an oil bath at 180° C. After 10 hours, by throwing the content in a large amount of methanol, the reaction is terminated, and the reaction product is reprecipitated. The reprecipitated product is collected by filtration, and washed with methanol several times (yield: 165 mg). The obtained reprecipitated product is fractionated with methylene chloride to obtain 128 mg of a soluble polymer (phenylpolystyrene carbonate) and 37 mg of an insoluble polymer. The weight average molecular weight (Mw) and the degree of molecular weight dispersion (Mw/Mn) of the polymer soluble in methylene chloride are respectively 22,500 and 2.1. The weight average molecular weight and number average molecular weight of phenylpolystyrene carbonate are respectively the weight average molecular weight and number average molecular weight found by dissolving the test sample for measurement in chloroform deuteride in concentration of 0.1 mass %, and measured by gel permeation chromatography. In the invention, HLC-8220GPC (manufactured by Tosoh Corporation) is used as the gel permeation chromatograph. The content of phenylcarbonate groups in the obtained phenylpolystyrene carbonate is 58.7 mass % based on all the amount of phenylpolystyrene carbonate. The obtained phenylpolystyrene carbonate shows the decomposition temperature of 410° C. and the residual rate at 600° C. of 13% in thermogravimetry in conformity with JIS K7120.

ABS shows the decomposition temperature of 380° C. and the residual rate at 600° C. of 8% in thermogravimetry in conformity with JIS K7120. Further, the content of phenylcarbonate groups of PC is 36 mass % based on all the amount of PC, the decomposition temperature is 470° C. and the residual rate at 600° C. is 20% in thermogravimetry in conformity with JIS K7120. Further, melamine sulfate as the radical trapping agent shows the decomposition temperature of 343° C. in thermogravimetry in conformity with JIS K7120.

### <Evaluation of Processability>

The melt flow rate of each of resin compositions in Examples 1 to 4 and Comparative Examples 1 to 7 is measured with F-W01 (manufactured by Toyo Seiki Seisaku-Sho, Ltd.) in conformity with JIS K7210. The results obtained are shown in Table 2 below.

### [Evaluation Test of Characteristics of Resin Mold]

By using each test piece (a resin mold) obtained in Examples 1 to 4 and Comparative Examples 1 to 7, characteristics evaluation test is performed according to the following procedure. The results obtained are shown in Table 2.

### <Evaluation of Combustibility (Exothermic Speed)>

By using the above ISO multipurpose dumbbell test piece, exothermic speed is measured with Cone Calorimeter (CONE III, manufactured by Toyo Seiki Seisaku-Sho, Ltd.) in conformity with ISO5660-1.

### <Evaluation of Combustibility (UL-94)>

UL-94 horizontal and vertical combustion test is performed with the UL test piece. The result of combustion test is higher level in the order of V-0, V-1, V-2 and HB, and level of V-2 or higher is required in many cases.

### <Evaluation of Heat Characteristics>

By using the above ISO multipurpose dumbbell test piece, the residual rate (%) at 600° C. is measured by thermogravimetry in conformity with JIS K7120.

### <Evaluation of Mechanical Characteristics (Stress at Yield)>

By using the above ISO multipurpose dumbbell test piece and AUTOGRAPH AG-IS-MS (manufactured by Shimadzu Corporation), stress at yield is measured by elastic stress rate of 50 (mm/min).

### <Evaluation of Mechanical Characteristics (Charpy Impact Resisting Strength)>

By using the above ISO multipurpose dumbbell test piece, Charpy impact resisting strength (kJ/m²) is measured with a digital impact resistance tester (DG-C, manufactured by Toyo Seiki Seisaku-Sho, Ltd.).

### <Evaluation of Recycling Properties>

The above ISO multipurpose dumbbell test piece is crushed, and the test piece after being crushed is again pelletized as the material with an extruder (model TEM-H, manufactured by Toshiba Machine Co., Ltd.), and injection molded with an injection molding press (model NEX360, manufactured by Nissei Plastic Industrial Co., Ltd.) on the condition of cylinder temperature of 220° C. and mold temperature of 40° C. to obtain ISO multipurpose dumbbell test piece (thickness: 40 mm, width: 10 mm). Crushing and molding are repeated five times. By using the obtained test piece, Charpy impact resisting strength (kJ/m²) after recycling is measured in the same manner as in the above evaluation of mechanical characteristics (Charpy impact resisting strength).

TABLE 2

| | | | Example | | | | Comparative Example | | | | | | |
|---|---|---|---|---|---|---|---|---|---|---|---|---|---|
| | | | 1 | 2 | 3 | 4 | 1 | 2 | 3 | 4 | 5 | 6 | 7 |
| Flame | Cone | Exothermic | 450 | 390 | 390 | 350 | 1,220 | 860 | 840 | 350 | 550 | 430 | 460 |
| resistance | Calorimeter | speed | | | | | | | | | | | |
| | | (KW/m²) | | | | | | | | | | | |
| | UL-94 | | V-2 | V-2 | V-2 | V-0 | HB | HB | HB | V-2 | V-2 | V-2 | V-2 |
| Heat | TG | Residual | 8 | 28 | 18 | 22 | 0 | 25 | 8 | 28 | 20 | 9 | 10 |
| characteristics | | rate at | | | | | | | | | | | |
| | | 600° C. (%) | | | | | | | | | | | |
| Mechanical | Stress at yield | (MPa) | 33 | 36 | 36 | 37 | 42 | 38 | 35 | 51 | 54 | 29 | 34 |
| characteristics | Charpy impact | (kJ/m²) | 12 | 13 | 12 | 11 | 18 | 15 | 5 | 19 | 55 | 8 | 12 |
| | resisting | | | | | | | | | | | | |
| | strength (CH) | | | | | | | | | | | | |
| Processability | MFR (220° C., | (g/min) | 49 | 60 | 55 | 61 | 58 | 68 | 45 | 88 | No | 12 | 65 |
| | 10 kg) | | | | | | | | | | flowing | | |
| Recycling | CH after | (kJ/m²) | 11 | 10 | 9 | 10 | 16 | 14 | 3 | 11 | 3 | 1 | 2 |
| properties | recycling | | | | | | | | | | | | |

What is claimed is:

1. A resin composition comprising:
a resin;
a radical trapping agent that has at least one of a phenol group, a nitrogen atom and a sulfuric acid group; and
a char-forming agent that has a carbonate group.

2. The resin composition according to claim 1, wherein
the radical trapping agent is a compound having a decomposition temperature lower than that of the resin in thermogravimetry in conformity with JIS K7120.

3. The resin composition according to claim 1, wherein
the radical trapping agent is a compound having at least one of a phenol group, a nitrogen atom and a sulfuric acid group.

4. The resin composition according to claim 1, wherein
the radical trapping agent is a compound having one or more sulfuric acid groups per one molecule.

5. The resin composition according to claim 1, wherein
the radical trapping agent is selected from the group consisting of melamine sulfate, guanidine sulfate, barium aminobenzenesulfonate, and aluminum benzimidazolesulfonate

6. The resin composition according to claim 1, wherein
the radical trapping agent is contained in an mount of from about 0.1 part by mass to about 50 parts by mass based on 100 parts by mass of the resin.

7. The resin composition according to claim 1, wherein
the char-forming agent is a compound having a residual rate at 600° C. of equal to or higher than that of the resin in thermogravimetry in conformity with JIS K7120.

8. The resin composition according to claim 1, wherein
the char-forming agent is selected from the group consisting of phenylpolystyrene carbonate, polycarbonate, polyphenylene ether, diphenyl carbonate, and triphenyl dicarbonate.

9. The resin composition according to claim 1, wherein
the char-forming agent is a compound having a phenylcarbonate group in an amount of about 35 mass % or more based on a total amount of the char-forming agent.

10. The resin composition according to claim 1, wherein
the char-forming agent is contained in an mount of from about 0.1 part by mass to about 100 parts by mass based on 100 parts by mass of the resin.

11. The resin composition according to claim 1, wherein
the radical trapping agent is melamine sulfate, and
the char-forming agent is phenylpolystyrene carbonate.

12. The resin composition according to claim 1, wherein
the resin is a compound having at least one of a styrene group and a phenylcarbonate group.

13. The resin composition according to claim 1, wherein
the resin is selected from the group consisting of acrylonitrile-butadiene-styrene copolymer (ABS), polycarbonate (PC), polystyrene (PS), acrylonitrile-styrene copolymer (AS), styrenephosphonic acid resin, styreneformalin resin, or styrol resin

14. A resin mold formed of the resin composition according to claim 1.
